(19) United States
(12) Patent Application Publication
(10) Pub. No.: US 2009/0224907 A1
(43) Pub. Date: Sep. 10, 2009

(54) Sanitation Tracking and Alerting System

(76) Inventors: Sidhartha R. Sinha, New York, NY (US); Colin Kennedy, Brooklyn, NY (US)

Correspondence Address: DOERNER, SAUNDERS, DANIEL & ANDERSON, LLP, 320 South Boston, Suite 500, Tulsa, OK, 74103-3725, US

(21) Appl. No.: 12/042,699

(22) Filed: Mar. 5, 2008

(51) Int. Cl. H04Q 7/00; G08B 13/00; G08B 23/00

(52) U.S. Cl. 340/539.11; 340/541; 340/573.1

(57) ABSTRACT

The invention provides a sanitization tracking and alerting system and method that automatically monitors hand sanitization actions of workers within a facility and reminds them of violations of hand sanitization requirements. The sanitization system may comprise a communications network providing interaction between a central computer with a database and one or more sanitizer dispenser systems, which dispense a sanitizer to the workers upon demand. The sanitizer dispensing system may have a reader for reading an identification device associated with the worker and a motion detector that detects when the worker is in the proximity of the dispensing mechanism. The sanitizer dispenser system may contain logic for determining which one of a number of workers in its vicinity may press a dispensing means, sending that information to the central computer, and activating an audio or visual indicator if the central computer determines that the worker is not sanitized, as determined by the length of time since the last hand sanitization event of the worker or whether or not the worker had done something that would require another hand sanitization action.

### BACKGROUND OF THE INVENTION

This invention involves generally the area of sanitation monitoring and enforcement, and more particularly, methods and devices for monitoring and enforcing rules dealing with personal sanitization, and even more particularly, a sanitizer dispenser system that uses a plurality of customized networked dispensers, which detect wireless identification devices worn by personnel in a facility, in order to monitor, record, detect, control, and/or enforce the use of sanitizers to clean hands.

Sanitization, and more specifically, the need to maintain clean hands, is important in numerous facilities. While numerous facilities, including restaurants, manufacturing plants, or food service facilities, may have such requirements, hospitals, clinics, or other types of healthcare facilities, in particular, have a need to maintain and enforce sanitary work environments in order to prevent infection and transmission of pathogens among patients and healthcare personnel or visitors, and between the external environment and the healthcare facility in general. Healthcare environments are ideal locations for the passing of infectious organisms from infected individuals to non-infected individuals. Without an affirmative policy of maintaining and enforcing strict guidelines for sanitization, such environments can become deadly. Not only does this mean the sanitization of equipment, rooms, and environment found in the facility, but also the maintenance of personal sanitization and hand hygiene among the hospital workers and visitors.

The simplest and most common method of maintaining personal sanitization among the hospital workers is the provision of germicidal or other antibacterial agents, i.e. sanitizers, in the patient's room, in the hallways outside the patients' rooms, or at other locations throughout the healthcare setting, e.g. in front of elevators, at the nursing stations, in bathrooms, etc. The worker is encouraged and expected to use such agents between sessions with different patients. Many hospitals require staff to use sanitizers to sanitize their hands before entering a patient's room and after exiting the room. With certain pathogens, it is often recommended to wash hands with soap and water and to also use an alcohol gel after washing.

Many healthcare settings have attempted to increase compliance with hand sanitization procedures by posting signs or by promoting hand hygiene education. However, the hospital worker is often preoccupied with care issues and, although aware of the need for personal hand hygiene to prevent the transmission of infectious agents, may forget or neglect to perform preventative actions, such as cleaning hands between patients. Numerous observations studies have documented very poor compliance with hand hygiene. It is estimated that over 2 million people in the US suffer from heath care associated infections, resulting in about 100,000 deaths, and costing billions of dollars. Neglecting hand hygiene may injure the patients or customers of the facility or company and thereby subject the facility or company to liability when it leads to an infection in the clients or customers that it services. While some hospitals are showing improvement in hand sanitization compliance, they are still not adequate and the data used to collect hand sanitization compliance is fraught with problems that calls into question the observed improvements in many cases.

There are also other settings that have requirements for personal sanitization in the form of hand cleansing. For example, restaurant and fast food facilities must adhere to local health department standards requiring their employees to wash their hands after attending the restroom. The most common way in which individuals sanitize their hands is by cleansing the hands with sanitization agents, i.e. soaps, alcohol-based cleansers, or other types of cleaning agents.

As can be seen, there is a need for an apparatus, method, and system that will monitor workers for compliance with sanitization standards and remind the worker when it is necessary to either wash or sanitize his hands in case he forgets or neglects to do so. The system should accomplish this by monitoring and/or recording the usage of sanitization agents between events that would require washing or sanitizing afterwards and, if the worker fails to take these actions between visits, to alert the worker and others to take remedial action.

### SUMMARY OF THE INVENTION

The invention provides a sanitizer dispenser system comprising a dispensing mechanism providing a means for sanitizing the hands of a person; a dispensing means providing the person the ability to cause the dispensing mechanism to sanitize the hands of the person, where the dispensing means sends an activation signal when the person interacts with the dispensing means; and a means of detecting the presence of the person within a selected distance of the sanitizer dispenser system and responsively sending a signal indicating motion detection.

More particularly, the invention provides a sanitizer dispenser system that comprises a dispensing mechanism having a sanitizing means for sanitizing a person's hands, where the dispensing mechanism is activated by the person and sends an activation signal when activated; a reader with a reader near view zone, the reader reading an identification device located within the reader near view zone and obtaining a worker identifier thereby, the identification device carried by the person, the reader sending a identification signal containing the worker identifier when the worker identifier is obtained; and a control module receiving the activation signal and the identification signal, such that the control module waits for a first time duration after receiving the identification signal for an activation signal; associates the worker identifier in the identification signal with the activation signal to create a hand sanitization event when the activation signal is received during the first time duration; and associates the worker identifier in the identification signal with a violation event when the first time duration expires without having received the activation signal.

The invention also provides a sanitization system for the detection and enforcement of hand sanitization rules for a person. The sanitization system comprises an identification device carried by the person, the identification device having a worker identifier; and capable of storing data (i.e. a worker's status); a central computer; a communications network; a database containing a file corresponding to each worker identifier, where the file contains a worker status and a list of events associated with the worker identifier; a plurality of sanitizer dispenser systems, where sanitizer dispenser system comprises a dispensing mechanism having a sanitizing means for sanitizing the person's hands and having an activating means that is volitionally activated by the person to cause the sanitizing of the person's hands by the dispensing mechanism, the activating means sending an activation signal when so activated; a reader with a reader near view zone and a reader far view zone allowing the reader to selectively read an identification device located within the reader near view zone or the reader far view zone and obtain the worker identifier thereby, with the reader sending an identification signal containing the worker identifier when the worker identifier is obtained; a communications interface allowing the sanitizer dispenser system and the central computer to exchange messages; and a control module receiving the activation signal and the identification signal, such that the control module waits for a first time duration after receiving the identification signal for an activation signal, associates the worker identifier in the identification signal with the activation signal to send a hand sanitization event message to the central computer when the activation signal is received during the first time duration, and associates the worker identifier in the identification signal with a violation event to send a violation event message to the central computer when the first time duration expires without having received the activation signal.

The invention also provides a hand sanitization method having a business rule, where the method comprises the steps of assigning a worker status of either “clean” or “unclean” to a worker, where the status is “clean” if the worker meets the business rule and is “unclean” otherwise; detecting when the worker having a status of “clean” does not meet the business rule; assigning the worker a status of “unclean” when the worker does not meet the business rule; detecting when the worker with a status of “unclean” is required to meet the business rule; detecting when the worker meets the business rule; and assigning a violation to the worker if the worker fails to meet the business rule when required to do so. The business rule may, for example, require the worker having a status of “unclean” to perform a hand sanitization action when the worker enters the room of a patient and within a selected time period after the worker enters the room.

These and other features, aspects and advantages of the present invention will become better understood with reference to the following drawings, description and claims.

### BRIEF DESCRIPTION OF THE DRAWINGS

FIG. 1 shows a schematic diagram of a sanitizer dispenser system, according to an embodiment of the invention;

FIG. 2 shows a schematic diagram of a facility sanitizer system in which the sanitizer dispenser system is configured, according to an embodiment of the invention;

FIG. 3 shows a schematic diagram of one configuration of a sanitizer dispenser in a patient's room within a healthcare facility, according to an embodiment of the invention;

FIG. 4 shows an exemplary flowchart for a Patient Approach Event, according to an embodiment of the invention;

FIG. 5 shows an exemplary flowchart for a Patient Exit Event, according to an embodiment of the invention;

FIG. 6 shows an exemplary flowchart for an Override Event, according to an embodiment of the invention;

FIG. 7 shows an exemplary flowchart for a timeout checking process executing on a central computer, according to an embodiment of the invention; and

FIG. 8 shows an exemplary flowchart for a message process executing on a central computer, according to an embodiment of the invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

For purposes of the following discussion, the terms “worker”, and “employee” will essentially mean the same thing, namely, any person normally within a facility who may be expected to conform to hand sanitization requirements. A worker may typically wear an identification badge that identifies the worker as being associated with the facility and provide authorization for the worker to have access to different areas of the facility. A visitor may also be required to conform to sanitization requirements, so the term “worker” may also embody the concept of “visitor” as it applies to such requirements. The embodiment of the invention discussed herein will assume a “facility” that may be such environments as a hospital, a clinic, a nursing home, a physician's office, a restaurant, a fast food establishment, food service/processing plant, or other manufacturing facility or some other operation in which care and service requiring cleanliness is rendered to a patient, customer, or client. However, the systems and methods described herein should not to be limited to such facilities and may be adapted to similar environments without departing from the scope of the invention. Furthermore, although the descriptions are directed to the sanitization of hands only, it should be noted that the principles of the invention may be applied to the sanitization of other body parts such as feet, arms, legs, and so forth, without departing from the scope of the invention.

The invention may provide systems, devices, and methods that use RFID (radio frequency identification device), UHF, portions of the industry, scientific, and medical (ISM) bands, wireless, or similar wireless technology to identify workers and to encourage these workers that are in a facility, such as one of those enumerated previously, to sanitize their hands, to track instances of such sanitization, and to note violations of sanitization policies that may be in force within the facility. The invention may find application in the healthcare industry by healthcare workers who must maintain a sanitary environment. Such facilities in which healthcare workers may be found are hospices, retirement homes, assisted living centers, clinics, emergency care facilities, hospitals, and the like. The invention may also find utility in applications that require workers to periodically perform specified actions between tasking, e.g. requiring restaurant or fast-food employees to sanitize and/or wash hands between trips to the bathroom or based upon leaving and entering the cooking area. The invention may also be adapted to provide alerts for other purposes besides sanitization of hands such as, for example, to remind staff in a hospital to clean their stethoscopes before and after patient visits.

In particular, the invention provides an innovative sanitizer dispenser system that reads an identification device carried by each worker to automatically check the worker's state of sanitization and alert the worker, if necessary, to sanitize his hands. In this way, rates of preventable infection should decline in hospitals and other settings. The identification device may be an RFID tag, which may be incorporated either with an ID badge that is typically carried by the worker or as a separate device for attachment elsewhere on their person. Ideally, the identification device may be sensed or “read” by wireless means so that an affirmative action is not required on the part of the worker to consciously present his identification device for sensing. All checking of the worker's status through sensing the identification device may be accomplished unobtrusively and without interfering with the worker's daily activities. Alternatively, the identification device may be a manual device, e.g. a magnetic card, that is presented to the sanitizer dispenser system in order to record the worker's use of the system and to enable the system to dispense its product for the worker.

One or more sanitizer dispenser systems may be located throughout the facility for dispensing a sanitizing agent for use by workers in sanitizing their hands. The sanitizer dispenser system may include a reader that detects the identification device and sets a worker status for the worker as “clean,” whenever the worker uses the sanitizer dispenser system. The system maintains a “clean” status for the worker for either a set period of time that is customizable or until another specified event occurs, e.g. a healthcare worker leaves a patient's room. This status may be recorded and tracked in a central database/network, on the identification device itself, or by other means known in the art. In this way, the hand sanitization status of all workers can be monitored on a regular basis, if desired, so that offenders may be reminded of lapses. Additionally, statistics may be collected and made available by floor, unit, type of health professional, and so forth through reports. They may also be provided to regulatory agencies such as the Joint Commission on Accreditation of Healthcare Organizations.

In one enablement, data regarding the worker's sanitization status may be stored on the worker's tag via RFID or similar technology instead of on a central computer by means well known in the art. RFID and similar tags currently support the ability to have data written to and stored on them. In this scenario, sanitization events would be stored on a worker's tag with a time stamp such that when a worker enters a reader's view zone, the reader would read the worker's tag to see when the worker last sanitized. If the worker was unclean and needed to sanitize, the system would alert the worker to do so. Depending on the desired business use, sanitization and violation events may be recorded on the worker's tag and then downloaded periodically be means well known in the art to a central database for reporting purposes. Alternatively, if such reporting is not desired, violation events would not be stored on workers' tags and workers would merely be reminded to sanitize if they were detected as unclean within a reader's view zone.

Associated with the use of the sanitizer dispenser systems of the invention are business rules that govern the conduct of the system with respect to general cleanliness and sanitization. The set of business rules may vary from facility to facility, depending upon the usage requirements and criticality of sanitization procedures. For example, such business rules may comprise the following: requirement to sanitize hands before approaching a patient/customer, a requirement to sanitize hands within a given grace period, and a requirement to sanitize hands within a certain time period after attending to a patient/customer. The system may be capable of being modified to accommodate different sets of such business rules. The pre-existing systems within a health care facility may impose special business rules upon a system of sanitizer dispenser systems provided under this invention. For example, high risk patients may require special sanitization procedures above and beyond those typically associated with the sanitization of hands; the sanitizer dispenser system set up to operate within such a patient's room may be set up to hinder entry into the room until the worker has sanitized his hands.

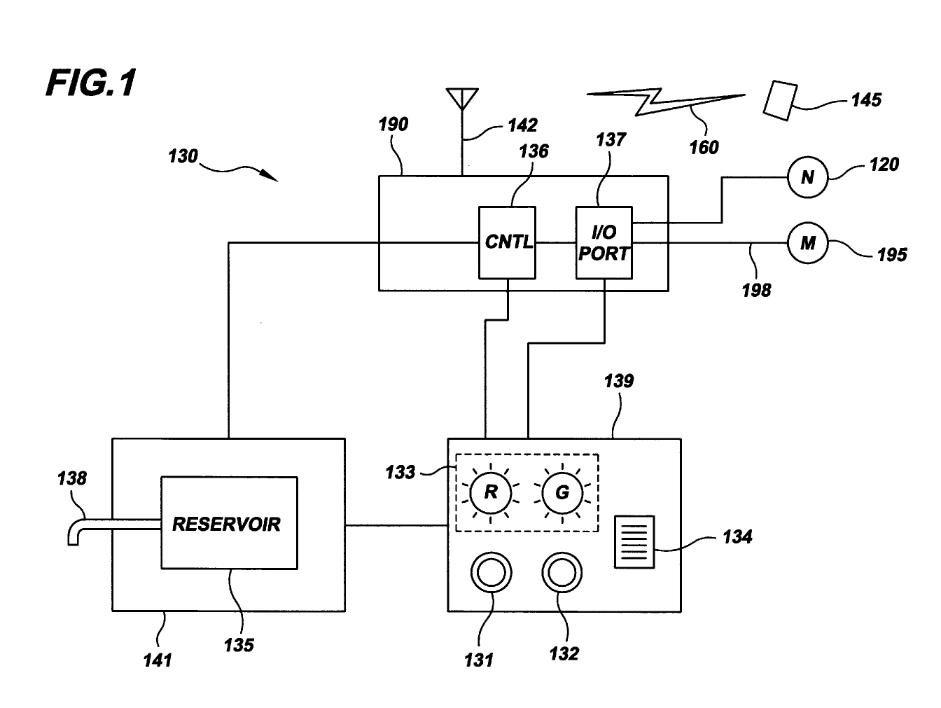

Referring now to FIG. 1, a schematic diagram of a sanitizer dispenser system 130 may be shown according an embodiment of the invention. The sanitizer dispenser system 130 may provide the functions of providing a means for sanitizing the hands of a person, such as for example, dispensing a quantity of sanitizer upon demand; identifying a worker using the sanitizer dispenser system 130; determining the status of the worker; and activating an alarm that indicates whether or not the worker needs to sanitize his/her hands. In order to perform these functions, embodiments of the sanitizer dispenser system 130 may contain various combinations of a dispensing mechanism 141, a reader 190, a control module 136, a motion detector 195, an antenna 142, an I/O port 137, and a panel 139.

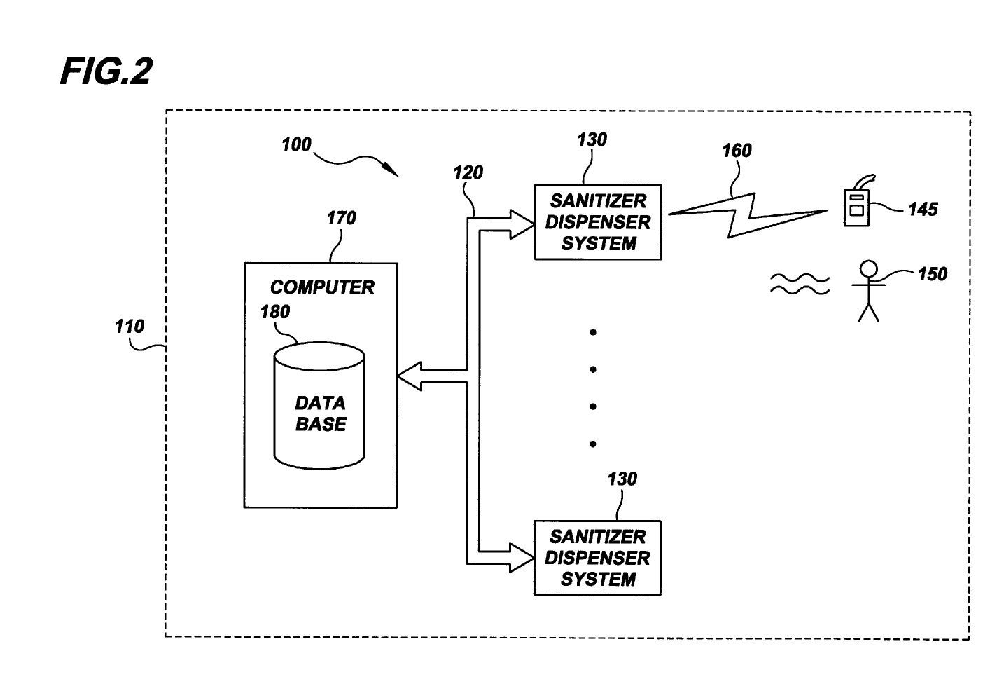

One or more sanitizer dispenser systems 130 may be provided within the facility to dispense sanitization products for the sanitization of healthcare workers' hands, and each sanitizer dispenser system 130 may be in communication with a central computer 170 (FIG. 2) through a communications network 120. Generally, the sanitizer dispenser system 130 may be configured to perform the functions of dispensing a sanitizer in response to a dispensing means 131, identifying the worker 150 that activated the dispensing means 131, determining a sanitization status for the worker 150, and activating an alert in the event of an unacceptable scenario. These functions will be discussed later.

In some embodiments, each sanitizer dispenser system 130 may be identified by a unique dispenser identifier so that the location of the sanitizer dispenser system 130 may be known in a facility; such a capability may be useful when several sanitizer dispenser systems 130 are configured throughout a facility. Sanitizer dispenser systems 130 may be located at central locations, such as nurse's stations, hallways, common areas, bathrooms or individual sanitizer dispenser systems 130 may be located in the room of each patient. The choice of location may be considered to be within the scope of the invention.

The dispensing mechanism 141 may be a standard mechanical, electrical, or mechanical-electrical device constructed in any manner that is well known in the art, for the purpose of dispensing a sanitizer. Such sanitizers may be soaps, alcohol-based materials, or other antibacterial or germicidal materials used for killing bacteria, viruses, and other infectious agents on the hands of the worker 150, but the choice of antipathogen product may be arbitrary and not within the scope of the invention. The dispensing mechanism 141 may have a reservoir 135 to hold the sanitizer. The dispensing mechanism 141 may be associated with a dispensing means 131 to cause the dispensing of the sanitizer, either by a mechanical or electrical means or a combination of the two. Such means are well known in the art and any suitable mechanism may be employed without departing from the scope of the invention.

Note that the dispensing mechanism 141 may be adapted for dispensing many different forms of sanitizer. For example, in some embodiments, the sanitizer may be in the form of a liquid, gel, or foam that may be contained in a reservoir 135. In other embodiments the sanitizer may be in the form of a solid product, such as a powder or a soap bar. In such cases, dispensing mechanisms 141 have been developed to provide an abrading device to grind off a measured amount of the sanitizer for the user when the sanitizer is in a solid form, or to measure out a given amount of powder when the sanitizer is in a powdered form. In still other embodiments, an ultraviolet light may be used to provide a timed exposure of the hands to the sanitizing effect of the ultraviolet light. In either example, the use of a reservoir 135 may not be required. While such embodiments of the sanitizer and dispensing device may be considered as within the scope of the invention, a liquid gel or foam may be more convenient to use and may require a much simpler mechanism, from a maintenance standpoint, and is preferred over a solid sanitizer with its more complicated dispensing mechanism 141. However, any sanitization modality may be used without departing from the scope of the invention.

The sanitizer dispenser system 130 may also have a control module 136 to perform logic operations and functions within the sanitizer dispenser system 130, which are necessary for the practice of the invention. The term “control module” may be used for purposes of discussion to describe the totality of control circuitry within the sanitizer dispenser system 130 that performs logic operations and functions. In practice, these functions may be distributed among different components of the sanitizer dispenser system 130 such as, for example, the panel 139 and the dispensing mechanism 141; it may also reside in a single physical location such as the reader 190. Either implementation may be employed without departing from the scope of the invention. For purposes of discussion, the control module 136 may be considered to be residing in the reader 190, but it should be kept in mind that this does not limit control functions exclusively to the reader 190. For example, one embodiment may contain a control module that may be actuated by a message from the central computer without intervention by the reader 190. Another embodiment may feature multiple control modules, one of which may be dedicated to the performance of message routing functions between such components as the reader, the panel, and a computer network.

The generic functions performed by the control module 136 may include, but not be limited to, providing a notification means by which external entities, such as workers in the proximity of the sanitizer dispenser system or external computer systems, with indications of the current state of the sanitizer dispenser system; controlling power to one or more antennas 142 associated with the reader; responding to signals from the panel 139 (for example, an activation signal and an override signal); tracking the location of personnel; checking the worker status in a central database or on the identification tag, etc. The function described as the notification means may be further described as providing a capability of sending and receiving messages on an external communications network; a capability of activating indicators to output indications to the worker 150 (for example, visual indicator means and the audible indicator means), or both.

The control module 136 may interact with devices that may be physically outside of the reader 190 or the sanitizer dispenser system 130 by means of an I/O port 137. The control module 136 and the I/O port 137 may be physically implemented by various means and methods well known in the art. For example, the control module 136 and the I/O port 137 may be constructed of integrated circuits and other electrical hardware. The logic functions performed by the control module 136 and the I/O port 137 may be performed by software components running on an embedded computer or they may be performed by hardwired logic such as a programmed logic array. Different combinations of physical implementations of each of the control module 136 and the I/O port 137 may be implemented and may be considered to be within the scope of the invention.

The sanitizer dispenser system 130 may also have a panel 139 provided as a human interface mechanism to allow a worker 150 to interact with the sanitizer dispenser system 130. Such interface mechanisms may be either input devices, output devices, or both. Input devices may be provided to allow the worker to cause the sanitizer dispenser system 130 to perform certain functions. Output devices may be provided as part of a notification means that gives the worker feedback relating to the operation of the sanitizer dispenser system 130 and the worker's status. The panel 139 may be located on an enclosure containing the various components of the sanitizer dispenser system 130 or as a separate enclosure. It may be positioned in such a way that a worker 150 may conveniently operate the sanitizer dispenser system 130 and to receive indications of activity, either audible or visual, from the sanitizer dispenser system 130. The panel 139 may contain numerous indicators that are provided as a means for notifying the worker of certain actions, such as lights, LEDs, and the like, for audiovisual output. The panel 139 may also contain switches (in the form of knobs, buttons, rocker switches, and the like) for manually causing the sanitizer dispenser system 130 to perform actions. It should be understood that the term “panel” may be used as a convenient way in which to group human interface mechanisms for purposes of discussion. Embodiments of the invention may distribute the different components of the panel 139 in other locations or may group all components literally into a single panel. Either construction may be used in practice without departing from the scope of the invention.

The panel 139 may contain as input devices a dispensing means 131 and an override means 132. The dispensing means 131 may be provided on the panel 139 to allow a worker to interact with the sanitizer dispensing system 130. The dispensing means 131 may cause the reservoir 135 to dispense the sanitizer through an outlet 138 into the hands of the worker 150. It may further provide an activation signal to the control module 136 to indicate that the dispensing means 131 has been activated, so that the control module 136 can take appropriate action. The nature of the activation signal, e.g. digital or analog, mechanical or electrical, etc., may not be essential to the invention, and may be implemented according to typical prior art methods and devices, but the control module 136 may thereby be made aware of the activation of the dispensing means 131 to initiate a function. The dispensing means 131 may be in the form of a knob, a lever, a button, a switch, a keyboard, or some other type of mechanism well known in the art without departing from the scope of the invention.

Similarly, an override means 132 may also be provided to allow the worker 150 to override the functions of the sanitizer dispenser system 130, to reset its state, or to otherwise cancel all activity of the sanitizer dispenser system 130 for a customizable period of time. It may further provide an override signal to the control module 136 to indicate that the override means 132 has been activated, so that the control module 136 can take appropriate action. Like the dispensing means 131, the nature of the override signal may not be essential to the invention, and may be implemented according to typical prior art methods and devices, as long as the control module 136 may be made aware of the activation of the override means 132 to initiate a function. The specific functions performed by the control module 136 in response to activation of the override means 132 may be dependent upon the particular environment, and this flexibility is considered to be within the scope of the invention. The override means 132 may be in the form of a knob, a lever, a button, a switch, or some other type of mechanism well known in the art without departing from the scope of the invention.

The panel 139 may contain as output devices a visual indicator means 133 and an audible indicator means 134. These indicator means 133, 134 may provide the worker with indications of the status of the system, general information (e.g. empty reservoir indication), alarms that are activated when a worker 150 having an “unclean” status approaches a patient, warnings, and the like. There are numerous examples of indicator means well known in the art such as lights, LEDs, bells, electronic sounds, digital screens, buzzers, and the like. For example, a green light may be provided to allow the sanitizer dispenser system 130 to inform the worker 150 that it has successfully assigned with worker with a “clean” status. Correspondingly, a red light may be provided to allow the sanitizer dispenser system 130 to inform the worker 150 that the worker 150 is not considered to be in a “clean” status, and instead is in an “unclean” status, to remind the worker 150 to take remedial actions, and to indicate that “unclean” status has been noted. Another clear light may be provided to simply indicate that the system is on and functioning properly. Alternatively, an audible indicator may be provided to alert the worker 150. Such audible indicators may include such things as a buzzer, an electronic tone, or some other auditory sound to alert the worker 150 as to an alarm condition; other auditory sounds can be used or auditory indicators may not be used according to other embodiments of the invention. These indicators may be chosen according to the needs of the specific implementation and are provided for example only; other indicator configurations may be used on the panel 139 without departing from the scope of the invention.

Note that when alerts are locally triggered and indicated by the indicator means 133, 134, the transmission of messages may also be initiated, as will be seen presently. When the sanitizer dispenser 130 is interconnected with other systems, it may send messages to the worker's supervisor or a central location where personnel are located who can deal with the situation in a more active manner. Such extensions of the alarm concept may be employed without departing from the scope of the invention.

The control module 136 may receive signals from the panel 139 and provide signals to the panel 139 in accordance with the operation of the control module. For example, the dispensing means 131 may provide the activation signal to the control module 136 to inform the control module 136 that the dispensing means 131 has been activated by a worker 150 to dispense sanitizer. Conversely, the control module may send a signal to the panel 139 to turn on or turn off an indicator light. The control module 136 may also exchange signals with the I/O port 137 to send and receive messages to external devices connected to the I/O port, for example, a motion detector 195 and a communications network 120.

A motion detector 195 may also be provided as a component of the sanitizer dispenser system 130, which serves to detect the proximity of a person to the sanitizer dispenser system 130. The motion detector 195 may have a motion detector view zone within which the motion detector 195 can detect the presence of the person and generate a signal in response to the detection of the person. The signal may be configured as a read request signal to cause the reader 190 to read the identification device 140 of a person who activated the motion detector 195. (This causation may be the result of a direct interaction between the motion detector 195 and the reader 190 or of an indirect interaction between the motion detector 195 and a control module 136 that responsively sends the read request signal to the reader 190, depending upon the implementation.) The means of detection may employ standard technology that is well known in the prior art, such as motion, infrared sensing, and the like. Any particular technology may be used to detect the proximity of a person to the sanitizer dispenser system 130 without departing from the scope of the invention.

Various components of the sanitizer dispenser system 130, i.e. the reader 190, the motion detector 195, the dispensing mechanism 141, the antenna(s) 142, and the panel 139 may be associated with each other in a modular fashion according to different embodiments and interconnected for remote operation, so that, for example, the reader 190 and the dispensing mechanism 141 can be configured in different locations under different scenarios. For example, the reader 190 may be collocated with the dispensing mechanism 141 within a room with the antenna 142 at the door, or the dispensing mechanism 141 may be collocated with the motion detector 195 in a room with the reader 190 and its antenna(s) 142 positioned above the doorframe and connected via a reader cable to the dispensing mechanism 141. In any event, the reader 190 may be positioned to detect the identification device 145 of the worker 150. The connection between components of the sanitizer dispenser system 130 may allow the components to be advantageously placed in locations other than that of the dispensing mechanism 141 so that it may be configured according to the environment. This remote interconnection may be accomplished by reasonable means, such as dedicated cable or wire, switched network, or wireless means, without departing from the scope of the invention.

The reader 190 may have one or more “view zones” for reception of a wireless signal 160 from the worker's identification device 145. A view zone may be defined by the type of antenna 142, the power associated with the reader 190, and the gain and radiation pattern of the antenna 142. By advantageous positioning of the reader 190 with respect to the dispensing mechanism 141 within a room, the reader 190 may determine which worker 150 from a group of workers 150 known by the reader 190 to be in a room may be in the nearest proximity to the dispensing mechanism 141 (i.e. which worker 150 activated the dispensing mechanism 141 to dispense sanitizer.) In one embodiment, this reader 190 may optionally be turned off by default, in order to reduce antenna emanations and save energy. Each sanitizer dispenser system 130 may have a motion detector 195 located in an optimized location to detect the presence of any human activity in a zone of the motion detector 195. If the motion detector 195 detects movement, then it may activate the reader 190, i.e. turn on the reader 190 by sending a read request signal, so that the reader 190 may read any identification devices 145 that may be in one of its view zones.

The reader 190 may be advantageously provided with a near view zone and a far view zone. This concept may provide a method through which the reader 190 may distinguish workers according to their distance from the reader 190. It may be useful in allowing the reader 190 to distinguish between, say, a worker that is in close proximity to and using or about to use the sanitizer dispenser system 130, and a worker who is in the general vicinity of the reader 190. This useful concept may be provided in the current technology by a configuration of the antenna 142. The reader 190 may be provided with either a near-field antenna, a far-field antenna, both a near-field and a far-field antenna, or a single antenna that can sense either near-field or far-field depending upon its gain control and sensitivity. For example, current near-field RFID technology may in general have a maximum read range of about 2 feet at 915 MHz and is insensitive to metal and liquid bodies between the identification device 145 and the antenna 142. Current far-field RFID technology may have a read range of from 10 feet to 15 feet. Other frequency bands may be used without departing from the scope of the invention. A combination of near-field and far-field antennas may be used on a reader 190 to provide detection of identification of hospital workers in a manner that will be described presently in an embodiment of the invention. Some embodiments of the reader 190 may comprise a single antenna 142, where the near zone and far zone are defined by changes in power level of the antenna 142. Other embodiments of the reader 190 may comprise two antennas 142, one for far field detection and one for near field detection. Some embodiments of the sanitizer dispenser system 130 may include two readers 190, each reader 190 having only a single antenna 142. Future embodiments may dispense with the need for a near view zone and identify the worker who is actuating the sanitizer dispenser system 130 by employing a biometric device or other technology in the actuating means that will read the worker's fingerprint.

Referring now to FIG. 2, an embodiment of the sanitizer dispenser system 130 may be shown as a component of a typical facility sanitizer system 100 configured according to the present invention. The facility sanitizer system 100 may be resident in a facility 110, such as a hospital, a clinic, a restaurant, or a hotel, for example. The facility sanitizer system 100 may comprise the following elements: identification devices 145, sanitizer dispenser systems 130, communications network 120, and a computer 170 hosting software components and a database 180. Other elements may be included in the facility sanitizer system 100 as needed.

An identification device 145 may be provided to each worker 150 that interacts with patients, clients, or customers that are within the facility 110. The identification device 145 may uniquely identify the worker 150 to sanitizer dispensing systems 130 by providing the reader 190 of the sanitizer dispensing system 130 with a worker identifier. The identification device 145 may preferably be a small electronic apparatus that is small enough to be carried about, attached to, or even imbedded in the worker without interfering with his/her daily activities. Such facilities 110 may sometimes provide workers 150 in the facility 110 with a badge that enables guards and other personnel to visually identify the worker employee as being authorized to work in the facility 110. In cases such as these, the identification device 145 may alternatively be incorporated into the badge for convenience, without departing from the scope of the invention.

In order to reduce mistakes or human error, it is desirable that the identification device 145 be automatic, i.e. that it transmits the worker identifier without interaction by the worker 150. However, other embodiments that would allow the worker to be identified to the system may be used without departing from the scope of the invention. For example, the worker may be required to key in the worker identifier on a keypad that may be part of the panel 139, in order to record his use of the system and/or enable the sanitizer dispenser 130 to dispense the sanitizer. A biometric reader may be used to read the worker's fingerprint when the worker presents himself at the sanitizer dispenser 130, whereupon the sanitizer dispenser 130 may initiate an identification process that would correlate the worker's fingerprint with a worker identifier. Other biometric readers could be used also, such as a retinal scanner. In another example, the worker may be provided with a magnetic card, much like a credit card, that the worker may swipe through a magnetic reader and thereby allow the sanitizer dispenser 130 to read the worker identifier from the magnetic card.

Since the worker 150 is generally mobile and moves from place to place within the facility 110, it may be desirable to use wireless technology in the identification device 145. A radio frequency identification (RFID) device may be a preferable technology for use in this context. In general, RFID devices broadcast a wireless signal to a receiver, or in this case, the reader 190. These RFID devices may be passive devices (or transponders) that respond with a pre-coded message when they receive a query signal. Alternatively, they may be active devices capable of carrying on a two-way dialog with the querying device. An active RFID device will typically require an on-board battery, be more expensive, and have more range than a passive RFID device. Furthermore, an active RFID device may be more flexible than a passive device, i.e. an active RFID device can be programmed to perform more complicated actions than a passive device and can support a more varied set of communications protocols. For purposes of the invention, an RFID device may preferably be employed as the identification device 145, but the use of active RFID devices or other communication technologies could also be employed without departing from the scope of the invention.

A communications network 120 may be provided to allow the sanitizer dispenser system 130 to interact with a central computer 170 and send information, i.e. worker identifier, that is obtained from its reader 190. Each sanitizer dispenser system 130 may send a signal containing the worker identifier obtained from its reader 190 over the communications network 120. When the signal is received by the central computer 170, the central computer 170 may contain software components that interact with a database 180 to record the information contained in the signal and perform actions to determine whether or not to issue an alert signifying the user is not sanitary according to predefined customizable parameters such as time, patient, acuity of illness, etc. As such, the central computer may interact and work in concert with the sanitizer dispensing system 130 in enforcing the business rules. Software components in the central computer 170 may also perform administrative functions in conjunction with the database 180 such as, for example, providing reports on system usage, statistics on average times for washing or sanitizing, numbers of infractions of the sanitization rules, and the like. The software may also have logic reflecting specific business rules for sounding alerts based on a person's sanitization status. For example, the software may dictate that people remain clean for T₁ time after sanitizing their hands and will send an alert when someone enters a patient's room without having sanitized in time T₂. Additionally, the software may work with the central computer to notify workers when a violation has occurred. This may be accomplished over a wireless network in which a page may be sent to the worker that is in violation. The worker's pager number may be associated with the worker's identifier in the database and the system may use means well known in the art to advise a worker when he has committed a violation.

It should be noted that the term “central computer” may include other computational configurations, such as a distributed network having many computational elements in different locations, which are coordinated and work cooperatively to perform the same functions that might be found in a single computer. Such configurations may be used to implement the intent of the invention without departing from its scope. Similarly, the term “database” should not be construed to be limited strictly to a single logical structure located at a central location, but may also include a distribution of database functions across other computational platforms and systems, such that these platforms and systems may operate cooperatively to implement the functions and intent described herein. The terms “database” and “central computer” are to be construed liberally and are used to facilitate discussion of the concepts included within the scope of the invention.

The database 180 may be organized to record events recorded by the reader 190, the worker identifier involved with the event, and the time the event occurred. There may be a number of different event types that are implemented within the system, depending upon the business rules that are in place. Examples of event types that may be recorded in the database may be a Hand Sanitization Event, Violation Event, Patient Approach Event, an Override Event, a Timeout Event, or a Patient Exit Event.

A Hand Sanitization Event may be defined for purposes of this discussion as an act of a worker 150 activating the dispensing means 131 of a dispensing mechanism 141. The Hand Sanitization Event may have other data associated with it, such as an associated reader identifier, which identifies the reader that detected the worker's presence at the dispensing mechanism 141 when the dispensing means 131 was activated, and a time stamp.

A Patient Approach Event may be defined for purposes of this discussion as an act of a worker 150 entering the room 200 of a patient 210. This event may be detected in different ways, depending upon the configuration of the sanitizer dispenser system 130 in a room. For example, a motion detector 195 may be positioned by the door 220 of the room to detect entry of a worker 150 and then a reader 190 may read all identification devices 145 within the room 200 to determine the identifiers within the room, compare the new identifiers with the previously read identifiers, and assign a Patient Approach Event to the worker 150 with the “new” identifier.

An Override Event may be defined for purposes of this discussion as an act of a worker 150 activating the override means 132. The association of the identifier of the worker 150 activating the override means 132 may be made in different ways, depending upon the configuration of the sanitizer dispenser system 130. For example, when the override means 132 is activated, the reader 190 collocated with the override means 132 may detect any identifier in its near view zone and associate the identifier of the worker 150 with the activation of the override means 132.

A Violation Event may be defined for purposes of this discussion in several different ways. For example, if a worker 150 enters a room 200 of a patient (Patient Approach Event) with an “unclean” status and the worker 150 fails to sanitize his hands within the time period T₂, then this may constitute a violation of the business rules of the facility, in which case a Violation Event may be posted to the worker's file. The posting of a Violation Event to the worker's file may be dependent upon the particular business rules in place for the facility, as will be discussed presently.

A Timeout Event may be defined for purposes of this discussion as the worker 150 not sanitizing his hands within the time period T₁ since the last Hand Sanitization Event by the worker 150. The Timeout Event may be detected by a continuous process running on the central computer, which may perform a check of all workers within the database to see if (1) the last event that was posted for the worker was a Hand Sanitization Event and (2) if time T1 has elapsed since the time stamp associated with the Hand Sanitization Event.

In general, the worker status may be the current status of the worker's state of sanitization, i.e. either “clean” or “unclean”. The facility sanitizer system 100 may optionally implement a business rule that provides a specified time period T₂ to a worker with an “unclean” status, during which the worker 150 may be allowed to sanitize his/her hands before assigning the worker 150 a worker status of “unclean”; conversely, if the worker 150 sanitizes his/her hands during the time period T₂, then the worker 150 may be assigned a status of “clean”, a Hand Sanitization Event may be recorded in the worker record, and a new time period T₁ may be initiated. If the time period T₁ elapses without the worker 150 performing a Hand Sanitization Event, then the worker 150 may automatically be assigned a status of “unclean”. Furthermore, an alarm may be initiated whenever a Patient Approach Event is recorded for the worker when the worker 150 has an “unclean” status; at that point, the worker 150 may optionally be given a time T₂ in which to sanitize his/her hands. The worker's subsequent behavior of sanitizing or not sanitizing his/her hands may be recorded in the database. Finally, the Patient Approach Event may be defined in numerous ways, depending upon the embodiment of the facility sanitizer system 100 and the business rules that are in place. For example, the system may recognize a Patient Approach Event whenever the worker 150 enters the patient's room or whenever the worker 150 is within an arbitrary distance D of patient. Other definitions of the Patient Approach Event may be used without departing from the scope of the invention.

A program product may be associated with the facility sanitizer system 100. It should be understood that the program product may comprise all software and firmware that resides on components of the facility sanitizer system 100 (e.g. central computer and control modules in the plurality of sanitizer dispenser systems 130 that are included in the facility sanitizer system 100) in order to implement a set of selected business rules in a global manner.

The central computer may contain several processes that may associated with the program product and that may functionally perform different tasks. For example, the central computer may contain a checking process that continuously checks each worker record in the database and maintains the current worker status, i.e. it may ascertain whether or not the worker's status needs to be changed according to the business rules and then make the change. The central computer may also contain an event process that receives different event messages associated with the workers, posts the event to the worker's record in the database, and takes what action is required to change the worker's status as a result. The central computer may also contain a report process that provides reports of worker activity with regards to sanitization of hands for use by supervisor and/or other personnel as needed. These reports may detail periods of time in which the workers have been in a “clean” or “unclean” status, and periods in which workers may have been in violation of the business rules with regards to sanitization of hands. Since events may be recorded for each worker, the events may be processed to provide reports of individual worker activity during the day, to include periods of “clean” and “unclean” status and violations of the business rules, if any. For example, a period of “clean” status may be calculated from the time of a Hand Sanitization Event until the time of a Timeout Event, with no intervening events.

These three processes are examples of the types of processes that may be appropriately performed from a central location such as the central computer. Other such processes may be implemented for execution within the central computer without departing from the scope of the invention.

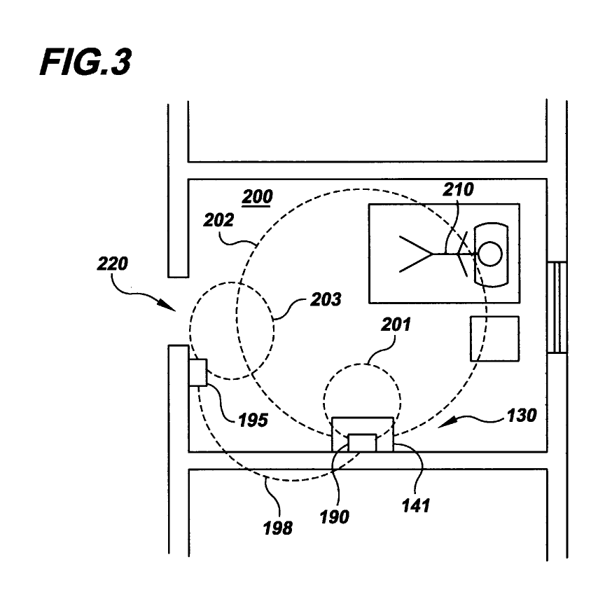

Referring now to FIG. 3, an embodiment of the invention may be shown for illustrative and discussion purposes, without limiting the intended scope of the invention, in which a sanitizer dispenser system 130 is installed in a room 200 of a patient 210 of a hospital facility. In this embodiment, a reader 190 having a near view zone 201 and far view zone 202 may be collocated with a dispensing mechanism 141, so that its far view zone 202 may detect any identification device 145 (not shown) for a worker 150 who may be present within the general confines of the room 200. The reader 190 may also have a near view zone 201 to detect the presence of an identification device 145 in close proximity to the dispensing mechanism 141 without detecting any other identification device 145 that may be in the room 200, and thereby associate the identifier of the worker 150 activating the dispensing mechanism 141 with the act of sanitizing the hands (i.e. a Hand Sanitizing Event for the worker 150). A motion detector 195 may be positioned in the general vicinity of the door 220 so that its motion view zone 203 will detect any entry of the worker 150 through a door 220 to the room 200. In this embodiment, the motion detector 195 may be connected to the sanitizer dispenser system by a motion detector cable 198. The dispensing mechanism 141 may be placed in a location within the room 200 such that the reader 190, when collocated with the dispensing mechanism 141, can detect any identification devices 145 that may be within a substantial portion of the room 200.

When a worker 150 enters a room or otherwise approaches a patient, a reader 190 may be positioned to detect the entry so that a Patient Approach Event can be ascertained. The reader 190 may send a message containing the worker identifier, an event type, and a time stamp to the central computer 170 to record a Patient Approach Event in the database 180. The central computer 170, may then access a record in the database 180, which corresponds to the worker 150, record the Patient Approach Event, and determine the worker status. If the worker status is not “clean”, then the central computer 170 may send a message containing the current worker status back the sanitizer dispenser system 130 that sent the original message, in order to notify the worker 150 that he/she has not sanitized his/her hands. The worker 150 may then be given a fixed amount of time by the central computer 170 or the sanitizer dispenser system 130, within which to sanitize his/her hands and avoid registering a violation on the worker's file. On the other hand, if the worker status is “clean” at the time of the Patient Approach Event, the central computer 170 may maintain the worker's status as “clean” until such time that the worker leaves the room (Patient Exit Event), at which time the worker's status may be changed to “unclean”.

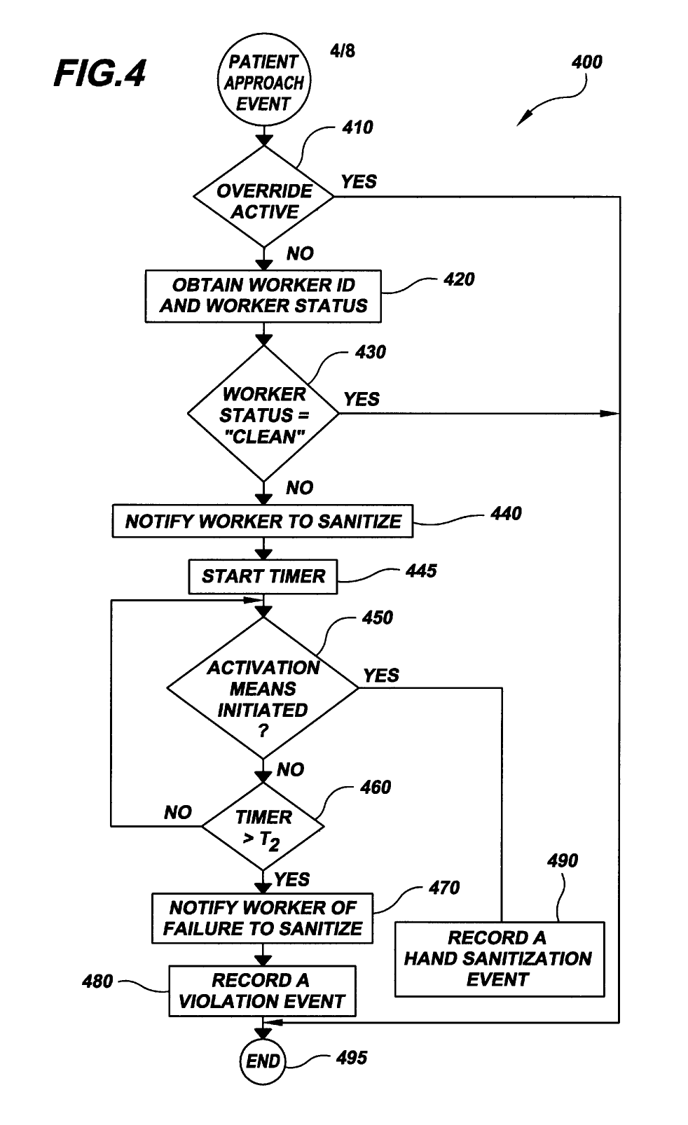

Referring to FIG. 4, a flowchart 400 is presented giving a typical, event-driven procedure that may be carried out for ensuring that the hands of a worker 150 have been sanitized when the worker 150 approaches a patient (a “Patient Approach” Event). The logic of the flowchart 400 may be initiated when the Patient Approach Event occurs. The sanitizer dispenser system 130 may first check to see if an Override Event has been previously asserted, according to the block designated as 401. This might occur if some previous occupant of the room had activated the override means to cause all checking of worker status and recording of violations to be inhibited until the last worker had left the room. The sanitizer dispenser system 130 may then obtain the worker identifier and worker status of the worker 150, according to the block labeled 420. This may be accomplished by the reader 190 querying the identification devices 145 within its far view zone 202 to determine the identifier of the worker 150 that just entered. A check is made to ascertain whether or not the worker status is “clean”, according to the block designated as 430. If the check is good, i.e. if the worker's status is “clean”, then the block designated as 495 may be executed to exit the flowchart. The worker status will remain “clean” as long as the worker is in the room.

If the worker's status is “unclean” (block 430) when the worker 150 enters the room, then the worker 150 will be notified to sanitize his/her hands by activating an alarm, signal, or some manner of notification, according to the block labeled 440. A timer may then be set to allow the worker 150 a time period T₂ in which to sanitize his hands, according to the block labeled 445. The system may wait until either the time T₂ elapses (according to the block designated as 460) or the worker activates the dispensing means 131 to dispense the sanitizer (according to the block designated as 450). If the period of time T₂ elapses without the dispensing means being activated, then the worker may be notified of a violation of the business rules of the facility, according to the block designated as 470. Such a notification may consist of an audible alarm, flashing lights, or some other manner that has been previously described. The central computer may be notified of a Violation Event for the worker 150, according to the block labeled 480. However, if the worker activates the dispensing means 131 before the grace period of time T₂ elapses (block 450), then the block designated as 490 may be executed to notify the central computer of a Hand Sanitization Event for the worker 150. In either event, the flowchart may then be exited (block 495).

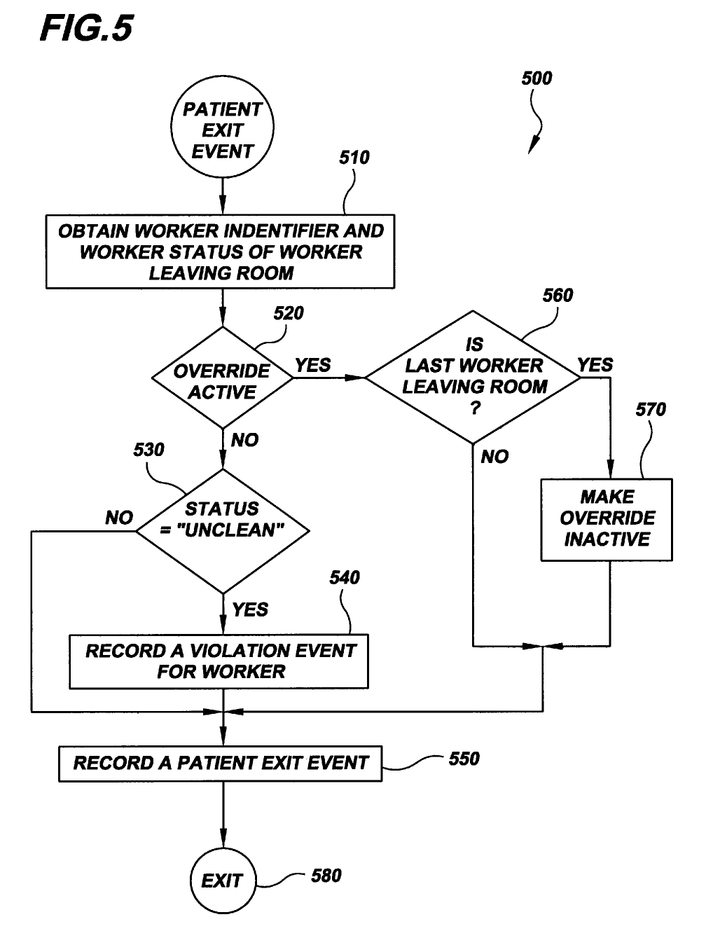

Referring to FIG. 5, a flowchart 500 is presented giving a typical, event-driven procedure that may be carried out whenever a worker 150 leaves the room 200 of a patient 210 (i.e. “Patient Exit” Event). The logic of the flowchart may be initiated when the sanitizer dispenser system 130 detects that a worker 150 has left the room and obtains the worker identifier and the worker status, according to the block designated as 510. Detection of this action may be accomplished in various ways, depending upon the configuration of the sanitizer dispenser system 130. For example, the motion detector 195 (FIG. 3) may be activated to cause the reader 190 to read all identification devices within its far field zone and make a list of all identifiers currently in the room. The reader 190 may then compare this list with the last such list and identify the worker 150 that has just left the room. Regardless of how the worker identifier is obtained, a check may be made to determine if an override action has been taken previously, according to the block labeled 520. If so, then a second check may be made to determine if the worker's status upon leaving the room was “unclean”, according to the block labeled 530. If an override is not currently active (block 520) and the worker's status when leaving the room is “unclean” (block 530), then the system will record a Violation Event. However, if either an override is currently active (block 520) or the worker's status when leaving the room is “clean” (block 530), no Violation Event is recorded for the worker. A Patient Exit Event may then be recorded for the worker, according to the block designated as 550. A check may then be made to see if the worker presently leaving the room was the last person in the room, according to the block labeled as 560. If so, then the override may be made inactive, according to the block labeled 570, and subsequent Violation Events may again be recorded.

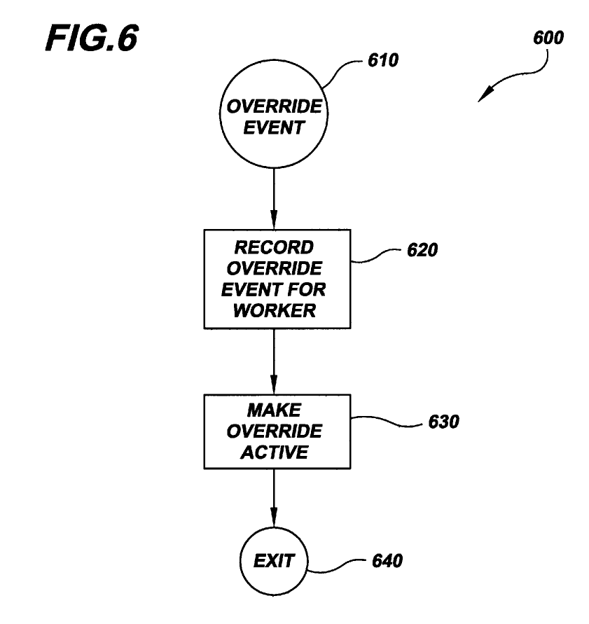

Referring to FIG. 6, a flowchart 600 is presented giving a typical, event driven procedure that may be carried out whenever a worker 150 activates the override means 132 in a sanitizer dispenser system 130 in the room 200 of a patient 210 (“Override Event”). The logic of the flowchart 600 may be initiated (block 610) when the sanitizer dispenser system 130 detects that the override means 132 has been activated. Detection of this action may be accomplished in various ways, depending upon the configuration of the sanitizer dispenser system 130. For example, the activation of the override means 132 may cause the reader 190 to read all identification devices within its near field zone to obtain the identifier of the worker 150 closest to the dispensing mechanism 141. Regardless of how the worker identifier is obtained, the system may record an Override Event for the worker 150 activating the override means 132, according to the block designated as 620, an Override Event message may be sent. The system may then make override to be active, in which case the system may inhibit the transmission of Violation Event messages and inhibit the display of any notifications to workers to sanitize their hands, according to the block designated as 630. When the last worker 150 has left the room (“Patient Exit” event), the sanitizer dispenser system 130 may return to a normal operation in which sanitization checks may be made. The flowchart 600 may then be exited (block 640).

A number of processes may be executed from the central computer in order to provide uniformity and consistency to the coordinated execution of a system containing a number of sanitizer dispenser systems, that may operate according to the flowcharts shown in FIGS. 4, 5, and 6. One such process may be a checking process that may continuously check the database record of each worker to ascertain whether or not the T₁ time period has been exceeded since the last Hand Sanitization Event for the worker. This process may be motivated by the fact that a worker may sanitize his hands at a sanitizer dispenser system that may not be within a patient's room; if the worker does not subsequently enter a patient's room (thus generating a Patient Approach Event), then the facility sanitization system may be unaware of the timeout of the T₁ time period for the worker and therefore mistakenly continue to maintain the worker's status as “clean”.

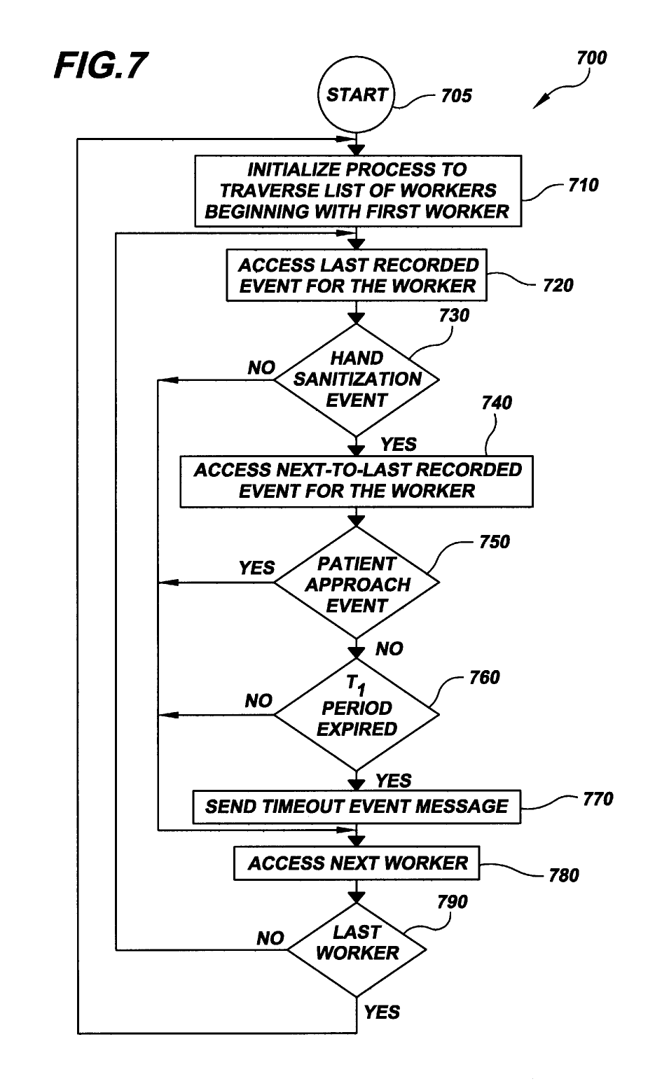

Referring now to FIG. 7, a flowchart 700 is presented giving a typical timeout checking process to ascertain if a worker's status is to change as the result of the worker not having sanitized his hands within the T₁ time period. The process may assume that all worker files that are on the database may be accessed sequentially as a list. The flow may be initiated at the block labeled as 705. The process may be initialized to start examining a sequential list of workers beginning with the first worker, according to the block labeled 710. A worker from the list may be accessed and the last event recorded for that worker may be examined, according to the block labeled 720. If the last recorded event for the worker is not a Hand Sanitization Event (block 730), then processing for this worker is complete and the next worker record may be accessed, according to block 780. Otherwise, the next-to-last event may be examined for the worker, according to block 740, to see if the worker may have performed a hand sanitization while in a patient's room. In other words, if the next-to-last event for the worker was a Patient Approach Event (block 750), then there is no need to check for a timeout of T₁ since the worker will retain a worker status of “clean” as long as the worker remains in the patient's room, regardless of whether the time period T₁ is exceeded or not. Therefore the processing for this worker may be complete and the next worker record may be accessed, according to block 780. Otherwise, the worker must have sanitized his hands at a sanitizer dispenser system that is outside a patient's room, and a check may be made to see if the time period T₁ after the last Hand Sanitization Event may have expired (block 760). If so, then the process may send a Timeout Event message and the next worker record may be accessed, according to block 780. If the current worker was the last worker in the list of workers, then the process may be initialized to examine the first worker in the list of workers, according to the block labeled 710.

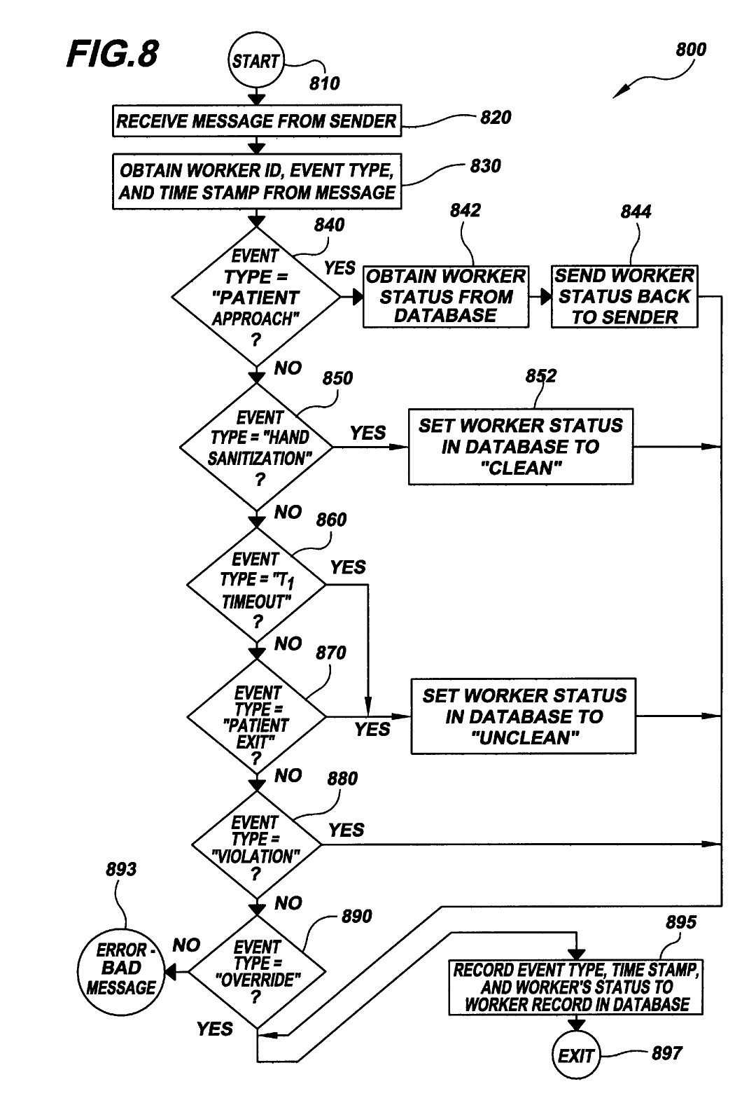

Referring now to FIG. 8, a flowchart 800 is presented giving a typical message processing process to receive all messages, whether sent by a sanitizer dispenser system or some other process within the central computer system (e.g. the timeout checking process). A process such as the message processing process described herein may be advantageously used to ensure that all changes of worker status are made by a single process within the system and not by multiple processes.

The process may be entered at block 810 when a message may be received from a sender, according to the block labeled 820. Such messages may be sent by a sanitizer dispenser system or another process within the central computer. Data contained in the message may be extracted, according to the block labeled 830. Such data may typically include, but not be limited to, a worker identifier, an event type, a time stamp indicating when the event occurred, and a sender identifier that identifies the entity sending the message. Note that a sender identifier may be necessary when the process finds it necessary to send a message back to the originator of the message being processed. The event type may then be examined and different processing performed, depending upon the business rules governing the handling of the event, according to the following actions:
(1) If the event type is a “Patient Approach” event (block 840), then the record in the database corresponding to the worker identifier may be accessed and the current worker status may be obtained, according to the block labeled 842. A message containing the current worker status may be formatted and sent back to the originator, according to the block labeled 844. This may be done so that the originating sanitizer dispenser system may be able to determine whether or not to notify the worker to sanitize his hands.
(2) If the event type is a “Hand Sanitization” event, then the worker status corresponding to the worker identifier may be changed to “clean”, according to the block labeled 842.
(3) If the event type is a “Timeout” event (block 860) or if the event type is a “Patient Exit” event, then the worker status corresponding to the worker identifier may be changed to “unclean”, according to the block labeled 875
(4) If the event type is not a “Violation” event (block 880) and the event type is not an “Override” event (block 890), then there must be some kind of error in the system since all possible event types have been examined and a system error may be asserted according to the block labeled 893.
   Regardless of the event type, all events may eventually be recorded in the database record corresponding to the worker identifier, according to block 895. The event being recorded may contain the event type, the time stamp, and the worker's status at present. When all message processing is complete, the flowchart may be terminated at block 897.

Thus the previous example of the operation of a facility sanitizer system 100 may show how the different components may be made to work together to provide a system for monitoring and enforcing hand sanitization within a health care facility. This example of operation of the facility sanitizer system 100 should not be taken to be limiting. It may be modified according to standard techniques used by information technology professionals to achieve the overall functions and goals of the invention. For example, although the exemplary methodology has been presented as being event-driven, the same result may be achieved by periodically executing a series of steps regardless of the present events in a round-robin procedure. Furthermore, the functions assigned to a particular process may be performed by other processes without departing from the scope of the invention, depending upon the specific constraints and limitations of the particular system. Other data processing techniques may be used to achieve the same result without departing from the scope of the invention.

Note that if the person or worker 150 using the dispensing mechanism 141 does not have an identification device 145, then the sanitizer dispenser system 130 may not perform any of the above steps and the Hand Sanitization Event will be ignored.

Note that the sanitizer dispenser system 130 may be used in configurations in which the sanitizer dispenser system 130 is standing alone and not in communication with a central computer 170. In this case, the sanitizer dispenser system 130 may be configured to detect movement within the far view zone 202 of the reader 190 and cause an audible or visual indicator to be activated, in order to remind workers 150 in the proximity of the sanitizer dispenser system 130 of the necessity of hand cleaning, whether needed or not. Alternatively, a motion detector 195 may be used in lieu of the reader 190.

Other embodiments of the invention may provide storage of the worker's status on the identification device carried by the worker. Such an embodiment may require the identification device to contain a storage capability to receive the worker status and may require the reader 190 to be capable of writing to the identification device as well as reading information from the identification device. Such embodiments may be used either with or in lieu of storage of the worker's status on the database.

Additionally, the sanitizer dispenser system 130 may be deployed with just a motion detector to detect motion a certain distance from the sanitizer dispenser system 130. It may be configured to issue an alarm whenever the motion detector detects movement within that distance. The purpose of this alarm would be to remind a person to sanitize his/her hands. Such a standalone system could be a more cost-effective, simpler solution to deploy since it may not require an interface with a central computer, the use of identification devices 190 by personnel, or a reader 190 as part of the sanitizer dispenser system 130.

The illustrative examples/embodiments presented heretofore have assumed a single patient per room. However, this should not be considered to be a limitation of the inventive concept. For example, it may be possible to have multiple patients within the same room. Such situations may be easily accommodated by installing multiple sanitizer dispenser systems 130 in the room, each system with its unique read/view zone directed towards a different patient and with the control logic modified accordingly. Such modifications may include a Patient Exit Event involving a worker leaving the read/view zone associated with one patient (or one sanitizer dispenser system 130 in a room) and not necessarily leaving the room; similarly, a Patient Approach Event may involve a worker simply entering a given read/view zone for a given patient in the room Another approach might involve an alert being sent after a certain customizable period of time; the alert would serve to remind the entering worker to sanitize his hands again when he is in a room with multiple patients.

In another embodiment of the facility sanitizer system 100, a worker tracking capability may be implemented by building upon the capability of the facility sanitizer system 100 to record Patient Approach Events, Patient Exit Events, and Hand Sanitization Events, since they can be used to locate the worker at a particular time. Being able to locate workers when needed can serve to increase patient safety. A report may be provided to track the location of a worker, based upon these events. Certain embodiments may also include additional readers deployed throughout a facility for purposes of worker tracking, in order to record a time when a worker enters their respective view zones and recording this “Location Event” in the central database. In operation, the reader would read the worker's identification device when the worker entered the reader's view zone and would send a message to that effect to the central database for recording, as with any event. The message may include the worker identifier, a reader identifier, and a time stamp. Thus, the facility sanitizer system 100 may also provide a generalized system to increase patient safety by being better able to locate healthcare workers when needed.

Along with the worker tracking capability, the facility sanitizer system 100 in still another embodiment may be modified to track patients as well. In this embodiment, each patient may have an identification device and the patient location could be tracked in the same manner as the worker location could be tracked. In this manner, a patient could be immediately located anywhere in the facility. For example, the record of a patient undergoing a series of diagnostic tests may be accessed in the database to determine where the patient was in the diagnostic process and a projected completion time may be extrapolated therefrom.

The location of the worker/patient would be recorded in the central database with every event (e.g., sanitization and violation events). The location of each reader would be known to the database via means well known in the art. When an event is associated with a worker/patient, the specific reader associated with that event would also be recorded such that the database log would reflect the time at which a worker/patient was within a given reader's view zone. Additional readers may be located throughout the facility to continuously scan tags of worker's/patient's within their view zone. Each time a person passes through a reader's view zone their location would be noted with a time stamp in the database.

In yet another embodiment of the facility sanitizer system 100, the sanitizer dispenser systems 130 may be located in or immediately outside operating rooms. Business rules and procedures for use in the operating rooms may require that the sanitizer dispenser system 130 be modified to ensure not only that the worker entering the operating room has sanitized his hands, but also that the worker sanitized his hands for a minimum amount of time. To do this, the sanitizer dispenser system 130 may be modified to implement a business rule that requires another timer to ensure that the worker remained in the near view zone for a minimum amount of time after activating the sanitizer dispenser system 130. It may also be modified to record a special violation event if the worker violated these rules and even to activate a special audible/visual alarm. Other special procedures may be implemented without departing from the scope of the invention.

In still another embodiment of the facility sanitizer system 100, it may be modified to account for visitors without departing from the scope of the invention. Business rules for the facility may require visitors, i.e. persons that are neither patients or workers, to be issued special identification devices and tracked while they are in the facility. These business rules may require special procedures to be carried out in the event of a violation event. For example, the business rules may require that security personnel be dispatched to the location of the visitor's violation event so that they can remove the visitor from the location. Other such business rules may be implemented in the case of visitors without departing from the scope of the invention.

In a further embodiment, the system may be deployed in restaurant restrooms, such that a reader in the restroom may read the identification device of a worker to see if the worker has used the sanitizer provided in the restroom by the sanitizer dispensing system before the worker leaves the restroom. The santizer may be one of the before-mentioned sanitizers but would typically be some kind of liquid soap.

As will be appreciated by one of skill in the art, embodiments of the present invention may be provided as methods, systems, or computer program products. Accordingly, the present invention may take the form of an entirely hardware embodiment, an entirely software embodiment, or an embodiment combining software and hardware aspects. Furthermore, the present invention may take the form of a computer program product which is embodied on one or more computer usable storage media (including, but not limited to, disk storage, CD-ROM, optical storage, electrically-erasable programmable read-only memory, and so forth) having computer usable program code embodied therein.

Portions of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, embedded processor or other programmable data processing apparatus to produce a machine, such that the instructions, which execute via the processor of the computer or other programmable data processing apparatus, create means for implementing the functions specified in the flowchart and/or block diagram block or blocks.

These computer program instructions may also be stored in a computer readable memory that can direct a computer or other programmable data processing apparatus to function in a particular manner, such that the instructions stored in the computer readable memory produce an article of manufacture including instruction means which implement the function specified in the flowchart and/or block diagram block or blocks.

The computer program instructions may further be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart and/or block diagram block or blocks.

Thus, an inventive sanitization system may be provided by the invention to detect and enforce the sanitization of a worker's hands in various environments, including especially the environment of a healthcare facility. It should be understood, of course, that the foregoing relates to preferred embodiments of the invention and that modifications may be made without departing from the spirit and scope of the invention as set forth in the following claims.

We claim:

1. A sanitizer dispenser system comprising
a dispensing mechanism providing a means for sanitizing the hands of a person;
an dispensing means providing the person the ability to cause the dispensing mechanism to sanitize the hands of the person, the dispensing means sending an activation signal when the person interacts with the activating means; and
a means of detecting the presence of the person within a selected distance of the sanitizer dispenser system and responsively sending a signal indicating motion detection.

2. The sanitizer dispenser system described in claim 1, wherein the means of detecting the presence of the person comprises
a motion detector with a motion detector view zone, the motion detector sending a motion detector signal when the person is within the motion detector view zone.

3. The sanitizer dispenser system described in claim 1, wherein the means of detecting the presence of the person comprises
a reader with a reader view zone, the reader receiving the activation signal and responsively reading an identification device associated with the person who is within the reader view zone to obtain an identifier.

4. The sanitizer dispenser system described in claim 1, further comprising
a notification means; and
a control module receiving the activation signal and the motion signal, wherein the control module
enables the notification means in response to receiving the motion signal and
inhibits the notification means in response to receiving the activation signal.

5. The sanitizer dispenser system described in claim 1, wherein the means for sanitizing the hands of a person is selected from a group consisting of dispensing a fixed amount of sanitizer liquid, dispensing a fixed amount of sanitizer solids, dispensing a fixed amount of sanitizer foam, dispensing a fixed amount of sanitizer gel, and providing a timed exposure of the person's hands to the sanitizing effect of an ultraviolet light.

6. The sanitizer dispenser system described in claim 1, further comprising
a motion detector with a motion detector view zone, the motion detector sending a motion signal when the person is within the motion detector view zone;
a reader having a first antenna with a reader view zone, the reader receiving the activation signal and responsively reading an identification device associated with the person who is within the reader view zone in order to obtain an identifier from the identification device;
a notification means; and
a control module receiving the activation signal and the motion signal, wherein the control module
enables the notification means in response to receiving the motion signal and
inhibits the notification means in response to receiving the activation signal.

7. The sanitizer dispenser system described in claim 6, wherein the reader view zone comprises a reader near view zone associated with a first distance and a reader far view zone associated with a second distance, and the first distance is less than the second distance.

8. The sanitizer dispenser system described in claim 6, wherein the reader comprises a second antenna having a reader far view zone associated with a second distance, the reader view zone is a reader near view zone associated with a first distance, and the first distance is less than the second distance.

9. The sanitizer dispenser system in claim 1, further comprising
an override means actuated by the person, the override means sending an override signal when the person actuates the override means, wherein the control module receives the override signal, inhibits the notification means, and ignores the activation signal.

10. A sanitizer dispenser system comprising:
a dispensing mechanism having a sanitizing means for sanitizing a person's hands, the dispensing mechanism being activated by the person and sending an activation signal when activated;
a reader with a reader near view zone, the reader reading an identification device located within the reader near view zone and obtaining a worker identifier thereby, the identification device carried by the person, the reader sending a identification signal containing the worker identifier when the worker identifier is obtained; and
a control module receiving the activation signal and the identification signal, wherein the control module
waits for a first time duration after receiving the identification signal for an activation signal;
associates the worker identifier in the identification signal with the activation signal to create a hand sanitization event when the activation signal is received during the first time duration; and
associates the worker identifier in the identification signal with a violation event when the first time duration expires without having received the activation signal.

11. The sanitizer dispenser system described in claim 10, wherein the reader independently reads the identification device located within the reader near view zone.

12. The sanitizer dispenser system described in claim 10, wherein the reader reads the identification device located within the reader near view zone in response to receiving a read request signal sent by the control module.

13. The sanitizer dispenser system described in claim 10, further comprising
a motion detector with a motion detector view zone, the motion detector sending a motion detector signal when the person is within the motion detector view zone.

14. The sanitizer dispenser system described in claim 13, wherein
the reader reads the identification device located within the reader near view zone in response to receiving a read request signal, and
the control module sends the read request signal in response to the motion detector signal.

15. The sanitizer dispenser system described in claim 14, wherein
The reader has a reader far view zone associated with a first distance, the reader near view zone being associated with a second distance, the first distance being greater than the second distance.

16. The sanitizer dispenser system described in claim 15, wherein
The reader has a first antenna defining the reader near view zone and a second antenna defining the reader far view zone.

17. The sanitizer dispenser system described in claim 15, wherein
The reader has an antenna operating at a first power level defining the reader near view zone and at a second power level defining the reader far view zone.

18. The sanitizer dispenser system described in claim 10, further comprising
a communications interface, wherein the sanitizer dispenser system sends messages to a communications network and receives messages from the communications network.

19. The sanitizer dispenser system described in claim 18, wherein the control module
sends the violation event message to the communications interface;
sends the hand sanitization event message to the communications interface; and
receives a worker status message from the communications interface.

20. The sanitizer dispenser system described in claim 14, further comprising
a notification means;
wherein the control module
enables the notification means in response to receiving the motion signal and
inhibits the notification means in response to receiving the activation signal.

21. A sanitization system for detection and enforcement of hand sanitization for a person, the sanitization system comprising:
an identification device carried by the person, the identification device having a worker identifier;
a central computer;
a communications network;
a database containing a file corresponding to each worker identifier, the file containing a worker status and a list of events associated with the worker identifier;
a plurality of sanitizer dispenser systems, each sanitizer dispenser system comprising:
a dispensing mechanism having a sanitizing means for sanitizing the person's hands, the dispensing mechanism having an activating means that is volitionally activated by the person to cause the sanitizing of the person's hands by the dispensing mechanism, the activating means sending an activation signal when so activated;
a reader with a reader near view zone and a reader far view zone, the reader selectively reading an identification device located within the reader near view zone and the reader far view zone, and obtaining the worker identifier thereby, the reader sending an identification signal containing the worker identifier when the worker identifier is obtained;
a communications interface, wherein the sanitizer dispenser system and the central computer can send and receive messages; and
a control module receiving the activation signal and the identification signal, wherein the control module
waits for a first time duration after receiving the identification signal for an activation signal;
associates the worker identifier in the identification signal with the activation signal to send a hand sanitization event message to the central computer when the activation signal is received during the first time duration; and
associates the worker identifier in the identification signal with a violation event to send a violation event message to the central computer when the first time duration expires without having received the activation signal.

22. The sanitization system of claim 21, wherein the reader sends a message to the identification device containing information related to events, the identification device receiving the message and storing the information related to events, wherein the location of the worker is also determined from the list of events stored in the worker's database.

23. A hand sanitization method with a business rule, the method comprising the following steps:
assigning a worker status to a worker, wherein the status is “clean” if the worker meets a business rule and is “unclean” otherwise;
detecting when the worker having a status of “clean” does not meet the business rule;
assigning the worker a status of “unclean” when the worker does not meet the business rule;
detecting when the worker with a status of “unclean” is required to meet the business rule;
detecting when the worker meets the business rule; and
assigning a violation to the worker if the worker fails to meet the business rule when required to do so.

24. The hand sanitization method of claim 23, wherein the business rule requires the worker having a status of “unclean” to perform a hand sanitization action.

25. The hand sanitization method of claim 24, wherein the business rule further requires that the hand sanitization action be performed when the worker enters the room of a patient.

26. The hand sanitization method of claim 25, wherein the business rule further requires that the hand sanitization action be performed within a selected time period after the worker enters the room of a patient.

27. The hand sanitization method of claim 23, wherein the business rule requires that the worker having a status of “clean” be assigned a status of “unclean” after a selected period of time since the last hand sanitization action performed by the worker.

28. The hand sanitization method of claim 23, wherein the business rule requires that the worker having a status of “unclean” be assigned a status of “clean” after the worker both performs a hand sanitization action and remains in a view zone for a minimum amount of time.

29. The hand sanitization method of claim 28, wherein the view zone is a near view zone of a reader associated with a sanitizer dispenser system.
